(19) United States
(12) Patent Application Publication
(10) Pub. No.: US 2026/0249931 A1
(43) Pub. Date: Aug. 27, 2026

(54) TRUCK BED ACCESSORY RAIL MOUNTING SYSTEMS

(71) Applicant: Toyota Motor Engineering & Manufacturing North America, Inc., Plano, TX (US)

(72) Inventor: Robert Ditner, Howell, MI (US)

(73) Assignees: Toyota Motor Engineering & Manufacturing North America, Inc., Plano, TX (US); Toyota Jidosha Kabushiki Kaisha, Aichi-ken (JP)

(21) Appl. No.: 19/064,345

(22) Filed: Feb. 26, 2025

(51) Int. Cl. B62D 33/02

(52) U.S. Cl. CPC B62D 33/0207

(57) ABSTRACT

An accessory rail mounting system includes a truck bed, first striker bolt, a second striker bolt, and an accessory rail. The truck bed having a floor and a front wall extending upward from the front wall. The first striker bolt extending upward from the floor. The second striker bolt spaced apart from the first striker bolt and extending upward from the floor. The accessory rail having a first notch and a second notch. The first notch and the second notch configured to releasably engage the first striker bolt and the second striker bolt to releasably couple the accessory rail to the truck bed.

### TECHNICAL FIELD

The present specification generally relates to systems for mounting an accessory rail in a vehicle and, more specifically, to a system for mounting an accessory rail in a trunk bed that is attachable to a truck without the need of tooling and without damaging the truck bed.

### BACKGROUND

Trucks typically have truck beds in which cargo can be transported. However, such cargo may shift and move during transport. Various accessories, e.g., bike rack, cargo boxes, and the like, may be fixed to the truck bed to secure certain type of cargo within the truck bed. Installation and/or removal of such accessories, racks, and/or rails to support such accessories, typically requires tooling and/or may subject the truck bed to damage. Accordingly, a need exists for improved structure to secure accessories to a truck bed without the need of tooling or causing damage to the truck bed.

### SUMMARY

In one embodiment, an accessory rail mounting system includes a truck bed, first striker bolt, a second striker bolt, and an accessory rail. The truck bed having a floor and a front wall extending upward from the front wall. The first striker bolt extending upward from the floor. The second striker bolt spaced apart from the first striker bolt and extending upward from the floor. The accessory rail having a first notch and a second notch. The first notch and the second notch configured to releasably engage the first striker bolt and the second striker bolt to releasably couple the accessory rail to the truck bed.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically depicts a perspective view of an accessory rail mounting system with an accessory rail for a vehicle in an uninstalled position, according to one or more embodiments shown and described herein;

FIG. 2 schematically depicts a top view of the accessory rail mounting system with the accessory rail for the vehicle in an installed position, according to one or more embodiments shown and described herein;

FIG. 3 schematically depicts a partial perspective view of a portion of the accessory rail being moved toward from the uninstalled position towards the installed position, according to one or more embodiments shown and described herein; and

FIG. 4 schematically depicts a partial cross-sectional view of a portion of the accessory rail at the installed position taken along the line 4-4 of FIG. 2, according to one or more embodiments shown and described herein.

### DETAILED DESCRIPTION

Embodiments described herein are directed to an accessory rail mounting system with an accessory rail having notches configured to releasably couple to striker bolts on a floor of a truck bed. The accessory rail mounting system allows a user to secure an accessory within the truck bed without the use of tooling or damaging the truck bed or accessory rail. Various embodiments of the accessory rail mounting system and the operation of the accessory rail mounting system are described in more detail herein. Whenever possible, the same reference numerals will be used throughout the drawings to refer to the same or like parts.

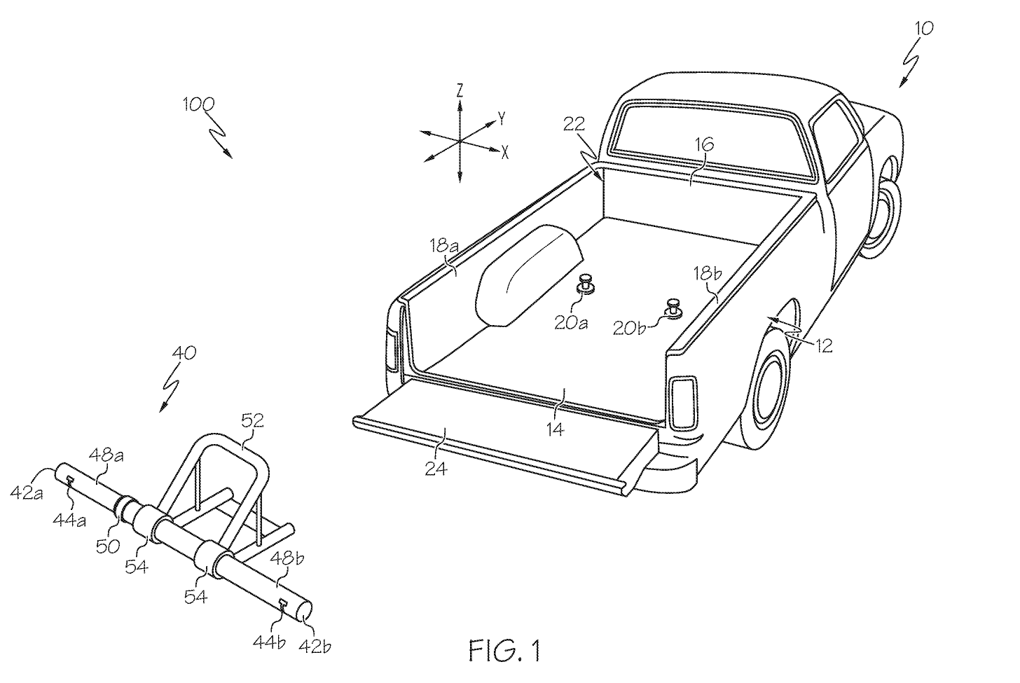

As used herein, the term “vehicle longitudinal direction” refers to the forward-rearward direction of the vehicle (i.e., in the +/- Y direction of the coordinate axes depicted in FIG. 1). The term “vehicle lateral direction” refers to the cross-vehicle direction (i.e., in the +/- X direction of the coordinate axes depicted in FIG. 1), and is transverse to the vehicle longitudinal direction. The term “vehicle vertical direction” refers to the upward-downward direction of the vehicle (i.e., in the +/- Z direction of the coordinate axes depicted in FIG. 1). As used herein, “upper” and “above” are defined as the positive Z direction of the coordinate axes shown in the drawings. “Lower” and “below” are defined as the negative Z direction of the coordinate axes shown in the drawings.

Referring now to FIG. 1, a vehicle 10 and an accessory rail mounting system 100 are shown. The accessory rail mounting system 100 includes a truck bed 12 with a first striker bolt 20a and a second striker bolt 20b and an accessory rail 40 with first notch 44a and a second notch 44b configured to releasably couple with the first striker bolt 20a and the second striker bolt 20b, respectively, to secure the accessory rail 40 to the truck bed 12.

The vehicle 10 may be a pick-up truck, or other suitable vehicle 10 than can support the truck bed 12. The vehicle 10 may be a passenger or commercial automobile. The vehicle 10 may include an electric, gas, or hybrid powertrain for propulsion. The vehicle 10 may be of a unibody construction in which a vehicle frame is unitary with a vehicle body (including frame rails, pillars, roof rails, etc.). As another example, the vehicle 10 may have a body-on-frame construction (also referred to as a cab-on-frame construction) in which the vehicle body and vehicle frame are separate components, i.e., are modular, and the vehicle body is supported on and affixed to the vehicle frame. Alternatively, the vehicle frame and vehicle body may have any suitable construction. The vehicle frame and vehicle body may be of any suitable material, for example, steel, aluminum, and/or fiber-reinforced plastic, etc. The vehicle body may define a passenger compartment to house occupants, if any, of the vehicle 10.

The truck bed 12 includes, for example, a floor 14, a front wall 16, a first sidewall 18a, and a second sidewall 18b. The truck bed 12, e.g., the floor 14, the front wall 16, the first sidewall 18a, and/or the second sidewall 18b may be formed of components of the vehicle frame and/or vehicle body. The truck bed 12, e.g., the floor 14, the front wall 16, the first sidewall 18a, and/or the second sidewall 18b may be fixed to, or otherwise supported by, components of the vehicle frame and/or vehicle body.

The front wall 16, the first sidewall 18a, and the second sidewall 18b may extend upward from the floor 14. The floor 14, the first sidewall 18a, and the second sidewall 18b may extend rearward from the front wall 16, e.g., away from the passenger cabin and towards a tailgate 24. The first sidewall 18a and the second sidewall 18b may be on opposite sides of the floor 14, e.g., the first sidewall 18a may be at a left side of the vehicle 10 and the second sidewall 18b may be at a right side of the vehicle 10. The floor 14, the front wall 16, the first sidewall 18a, and the second sidewall 18b collectively define a cargo volume 22. The cargo volume 22 is a volume in which cargo may be disposed within the truck bed 12. The cargo volume 22 may be above the vehicle 10 floor 14, e.g., along a vehicle vertical direction. The cargo volume 22 may be between the first sidewall 18a and the second sidewall 18b along a vehicle lateral direction. The cargo volume 22 may be between the front wall 16 and the tailgate 24 along a vehicle longitudinal direction. The tailgate 24 may be movable between an open position and a closed position, e.g., to increase ease in which cargo can be added or removed from cargo volume 22.

The floor 14, the front wall 16, the first sidewall 18a, and/or the second sidewall 18b may each include liners, e.g., to provide a robust surface to support cargo placed in the truck bed 12. The liners may be monolithic. For the purposes of this disclosure, “monolithic” means a single-piece unit, i.e., a continuous piece of material without any fasteners, joints, welding, adhesives, etc., fixing multiple pieces to each other. For example, liners of the floor 14, the front wall 16, the first sidewall 18a, and/or the second sidewall 18b may be provided by a single molded structure. Alternately, one or more liners of the floor 14, the front wall 16, the first sidewall 18a, and/or the second sidewall 18b may be separate. The separate liners of the floor 14, the front wall 16, the first sidewall 18a, and/or the second sidewall 18b may be fixed to each other, e.g., with a fastener, adhesive, or the like.

The first striker bolt 20a and the second striker bolt 20b are included to provide attachment points, e.g., to secure cargo within the cargo volume 22. The first striker bolt 20a and the second striker bolt 20b may be fixed to the floor 14, the vehicle body, and/or the vehicle frame, e.g., via weld, threaded engagement, with a nut, etc. The first striker bolt 20a and the second striker bolt 20b extend upward from the floor 14, e.g., along the vehicle vertical direction. The first striker bolt 20a is spaced from the second striker bolt 20b, e.g., along the vehicle lateral direction. The first striker bolt 20a and the second striker bolt 20b are spaced from the front wall 16, e.g., along the vehicle longitudinal direction. It is appreciated that the accessory rail mounting system 100 may include more than two striker bolts.

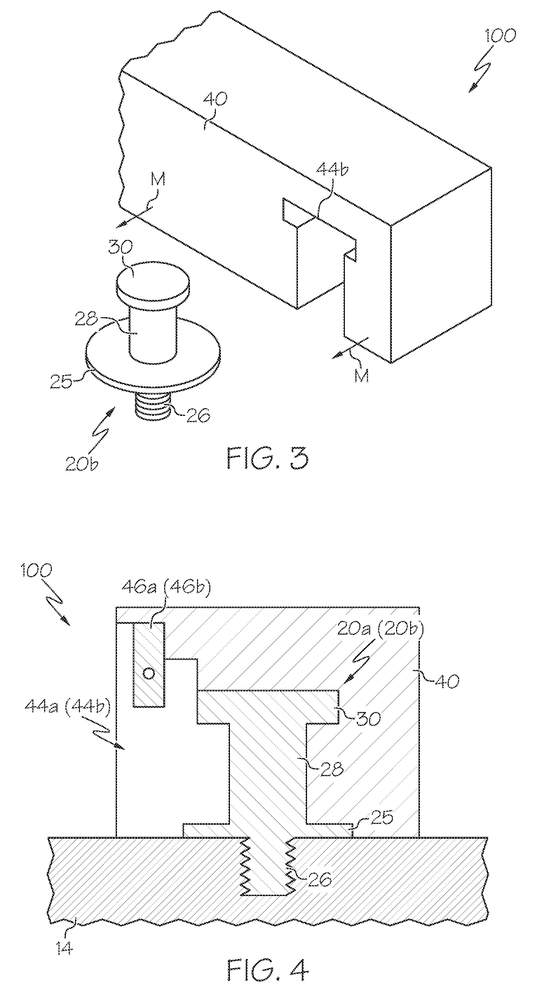

Referring to FIG. 3, the first striker bolt 20a and the second striker bolt 20b may each include a threaded portion 26, a flange 25, a shank 28, and a head 30. The flange 25 may be positioned between the threaded portion 26 and the shank 28. The shank 28 may be position between the flange 25 and the head 30. The head 30 may have a larger diameter than the shank 28. The threaded portion 26 includes an external thread, e.g., a helical machine thread configured to engage a nut, threaded hole, or the like. The flange 25 is a radially extending flange. The shank 28 may include a generally smooth outer surface. The shank 28 may be cylindrical or other suitable shape. The threaded portion 26 may be engaged within an internally threaded opening formed in the floor 14, the vehicle body, and/or the vehicle frame. For example, the threaded portion 26 may be in threaded engagement with a weld nut fixed to the floor 14, the vehicle body, and/or the vehicle frame. The shank 28 may extend upward from the floor 14, e.g., along the vehicle vertical direction. The head 30 may be spaced above the floor 14, e.g., along the vehicle vertical direction. The flange 25 abuts a surface of the floor 14 to allow for proper orientation of the shank 28 and head 30 with respect to the floor 14.

The accessory rail 40 is included to provide structure to secure an accessory 52, i.e., a structure configured to secure, support or store an item, within the cargo volume 22, e.g., when such accessory 52 is not suited for attachment directly to tie downs or the like of the truck bed 12. For example and without limitation, the accessory 52 may be a wheel chock configured to support a wheel of a motorcycle, all-terrain vehicle, or the like, as shown in FIG. 1. Other non-limiting examples of the accessory 52 include structure configured to support or secure to a kayak, canoe, bicycle, or the like. Further non-limiting examples of the accessory 52 include structure configured to store tools, hunting equipment, camping equipment, or the like.

The accessory 52 may be coupled to the accessory rail 40, as shown in FIG. 1. Coupling the accessory 52 to the accessory rail 40 secures the accessory 52 to the accessory rail 40 and limits relative motion therebetween. The accessory 52 may be releasably coupled to the accessory rail 40. For example, the accessory 52 may be connected with a clamp 54, latch, or the like that permits a user to couple and release the accessory 52 by hand and without tooling (e.g., without a screwdriver, wrench, etc.). The accessory 52 may be substantially permanently attached to the accessory rail 40. As used herein, substantially permanently attached means fixed relative to each other and requiring damage or tooling to separate. For example, the accessory 52 may be welded, secured with fasteners or the like that require tooling to remove, etc. The accessory rail 40 may be steel, aluminum, or any material of suitable strength to support the accessory 52 and/or other structure attached thereto. A cross-sectional shape of the accessory rail 40 may be tubular, square, round, or any suitable shape.

The accessory rail 40 defines a length, e.g., from a first distal end 42a of the accessory rail 40 to an opposite second distal end 42b of the accessory rail 40. The length of the accessory rail 40 is, in certain examples, adjustable. In other words, the accessory rail 40 can be adjust to increase and/or decrease a distance between the opposing first distal end 42a and the second distal end 42b of the accessory rail 40. In certain examples, the accessory rail 40 includes a first telescoping portion 48a and a second telescoping portion 48b. The first telescoping portion 48a can slide, for example, relative to and along the second telescoping portion 48b to adjust the length of the accessory rail 40. In certain examples, the first telescoping portion 48a and the second telescoping portion 48b are concentric, e.g., with the first telescoping portion 48a disposed in the second telescoping portion 48b, or vice versa.

A lock 50 is included, in some examples, to maintain the length of the accessory rail 40. The lock 50 can maintain the length by restricting movement of the first telescoping portion 48a relative to the second telescoping portion 48b. A user can actuate the lock 50 from a locked position that maintains the length to an unlocked position that permits adjustment of the length. The lock 50 includes, for example and without limitation, one or more of a clamp, a collar, a pin that can engage with openings of one or both of the portions 48a, 48b, or other suitable structure for selectively permitting or inhibiting movement of the first telescoping portion 48a relative to the second telescoping portion 48b.

The first notch 44a and the second notch 44b are included in the accessory rail 40 to secure the accessory rail 40 to the first striker bolt 20a and the second striker bolt 20b. The first notch 44a and the second notch 44b are configured to releasably couple to the first striker bolt 20a or the second striker bolt 20b. The first notch 44a and the second notch 44b may define a void shaped and sized to conform to the shank 28 and the head 30. The first notch 44a and the second notch 44b are open to permit that shank 28 and the head 30 to be inserted into respective portions of the void. Once the first striker bolt 20a or the second striker bolt 20b are inserted, e.g., coupled, to first notch 44a and the second notch 44b, the solid structure surrounding the void may restrict moment of the accessory rail 40, e.g., in directions other than a direction to remove the first striker bolt 20a and the second striker bolt 20b from the first notch 44a and the second notch 44b. The first notch 44a and the second notch 44b can be released from the first notch 44a and the second notch 44b, for example, by moving the accessory rail 40 such that the first striker bolt 20a and the second striker bolt 20b are moved out of the voids through the openings of the first notch 44a and the second notch 44b.

Adjusting the length of the accessory rail 40, in some examples, adjusts a distance from the first notch 44a to the second notch 44b. For example, and without limitation, the first notch 44a may be at the first telescoping portion 48a and the second notch 44b may be at the second telescoping portion 48b. In such example, moving the first telescoping portion 48a relative to the second telescoping portion 48b move the first notch 44a relative to the second notch 44b.

Referring to FIG. 4, the accessory rail 40 includes a first latch 46a at the first notch 44a and a second latch 46b at the second notch 44b. The one first latch 46a and the second latch 46b are configured to releasably couple to the first striker bolt 20a and the second striker bolt 20b, e.g., the first latch 46a may be releasably coupled to the first striker bolt 20a and the second latch 46b may be releasably coupled to the second striker bolt 20b. The first latch 46a and the second latch 46b maintain the first striker bolt 20a and the second striker bolt 20b within the first notch 44a and the second notch 44b, e.g., until a user interacts the first latch 46a and the second latch 46b to release the first striker bolt 20a and the second striker bolt 20b. The first latch 46a and the second latch 46b may include for example, a hook, a striker, a pin, a bolt, a spring, and/or other suitable structure for releasably coupling to the first striker bolt 20a and/or the second striker bolt 20b within the first notch 44a and the second notch 44b, i.e., without damaging the truck bed 12, the accessory rail 40, etc., and without requiring tooling. Coupling the first latch 46a and the second latch 46b to the first striker bolt 20a and the second striker bolt 20b limits movement of the accessory rail 40 relative to the truck bed 12. Uncoupling, e.g., releasing, the first latch 46a and the second latch 46b from the first striker bolt 20a and the second striker bolt 20b frees movement of the accessory rail 40 relative to the truck bed 12, e.g., such that the first striker bolt 20a and the second striker bolt 20b can be moved out of the first notch 44a and the second notch 44b. The first latch 46a and the second latch 46b may generally maintain coupling with the first striker bolt 20a and the second striker bolt 20b, e.g., such that actuation of the first latch 46a and the second latch 46b by a user is required to release the first latch 46a and the second latch 46b. The first latch 46a and the second latch 46b are movable between a closed position and an open position. In the closed position, the first latch 46a and the second latch 46b inhibits movement of the accessory rail 40 with respect to the first striker bolt 20a and the second striker bolt 20b to secure the accessory rail 40 to the truck bed 12 such that the accessory rail 40 can be used to secure cargo while the vehicle 10 travels. In the open position, the first latch 46a and the second latch 46b permit movement of the accessory rail 40 with respect to the first striker bolt 20a and the second striker bolt 20b to allow the accessory rail 40 to be removed from the truck bed 12.

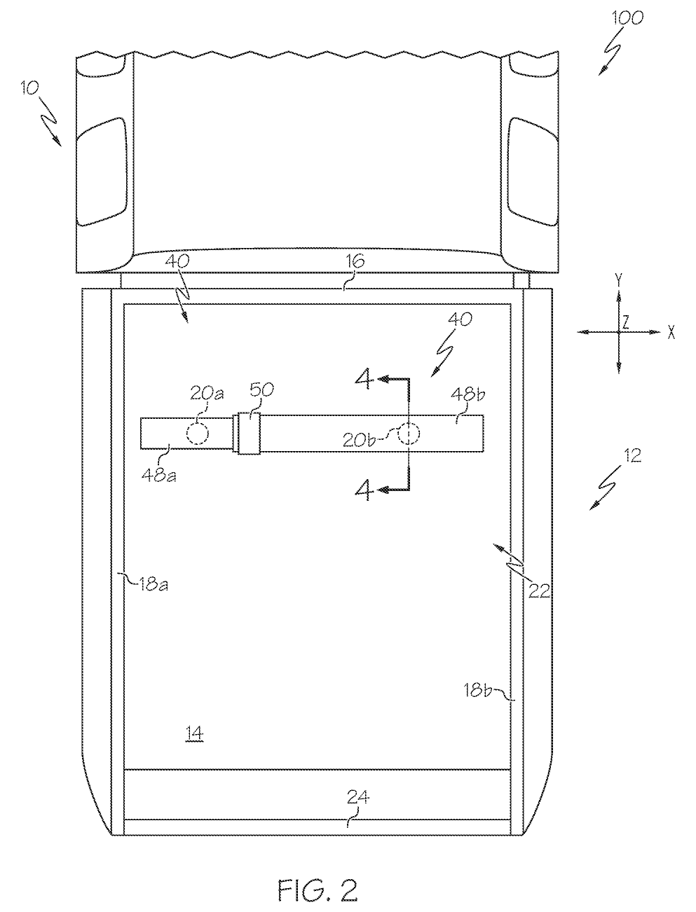

The accessory rail 40 is movable from an uninstalled position (e.g., as shown in FIGS. 1 and 3) to an installed position (e.g., as shown in FIGS. 2 and 4). For ease of illustration, the accessory 52 is not shown in FIG. 2 (e.g., the accessory 52 is released from the accessory rail 40 and positioned out of view). A user may install the accessory rail 40, i.e., move the accessory rail 40 to the installed position, by coupling the first notch 44a and the first latch 46a with the first striker bolt 20a, and coupling the second notch 44b and the second latch 46b to the second striker bolt 20b, e.g., by translating the accessory rail 40 to move the first striker bolt 20a and the second striker bolt 20b through the openings of the first notch 44a and the second notch 44b, e.g., as shown in FIG. 3 where arrows M represent movement of the accessory rail 40 toward the installed position. A user may uninstall the accessory rail 40, i.e., move the accessory rail 40 to the uninstalled position, by releasing the first latch 46a and the second latch 46b and uncoupling the first notch 44a and the second notch 44b from the first striker bolt 20a and the second striker bolt 20b.

With reference to FIGS. 1 and 3, at the uninstalled position the first notch 44a and the second notch 44b are not coupled with the first striker bolt 20a and the second striker bolt 20b,, i.e., such that the accessory rail 40 can be moved, e.g., freely, relative to the truck bed 12. The accessory rail 40 at the uninstalled position may be separated from the truck bed 12, e.g., for storage in a garage or the like until a user desires to install the accessory 52 rack to the truck bed 12.

With reference to FIGS. 2 and 4, at the installed position the first striker bolt 20a and the second striker bolt 20b are at least partially received within the first notch 44a and the second notch 44b, i.e., such that movement the accessory rail 40 is limited relative to the truck bed 12, and in particular relative to the first striker bolt 20a and the second striker bolt 20b.. The first latch 46a and the second latch 46b may further limit move of the accessory rail 40 at the installed position, e.g., by maintaining the first striker bolt 20a and the second striker bolt 20b in the first notch 44a and the second notch 44b as discussed above. The accessory rail 40 at the installed position may be disposed in the cargo volume 22, e.g., between the first sidewall 18a and the second sidewall 18b along the vehicle lateral direction and between the front wall 16 and the tailgate 24 along the vehicle longitudinal direction. In certain examples, the accessory rail 40 at the installed position abuts the floor 14. For example, the accessory rail 40 may be disposed on a top surface of the liner of the floor 14.

From the above, it is to be appreciated that defined herein is an apparatus is attachable to a truck bed without the need of tooling and without damaging the truck bed and can support cargo in the trunk bed.

It is noted that the term "generally" may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

As used herein, the singular forms “a,” “an” and “the” include plural referents unless the context clearly dictates otherwise. Thus, for example, reference to “a” component includes aspects having two or more such components, unless the context clearly indicates otherwise.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

While particular embodiments have been illustrated and described herein, it should be understood that various other changes and modifications may be made without departing from the scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. An accessory rail mounting system comprising:
a truck bed having a floor and a front wall extending upward from the front wall;
a first striker bolt extending upward from the floor;
a second striker bolt spaced apart from the first striker bolt and extending upward from the floor; and
an accessory rail having a first notch and a second notch, the first notch and the second notch configured to releasably engage the first striker bolt and the second striker bolt to releasably couple the accessory rail to the truck bed.

2. The accessory rail mounting system of claim 1, further comprising an accessory coupled to the accessory rail.

3. The accessory rail mounting system of claim 2, wherein the accessory is releasably coupled to the accessory rail.

4. The accessory rail mounting system of claim 2, wherein the accessory is fixed to the accessory rail.

5. The accessory rail mounting system of claim 2, wherein the accessory is a wheel chock.

6. The accessory rail mounting system of claim 1, wherein the accessory rail is movable from an uninstalled position to an installed position, at the uninstalled position the first notch and the second notch are spaced apart from the first striker bolt and the second striker bolt, and at the installed position the first notch and the second notch at least partially received within the first striker bolt and the second striker bolt.

7. The accessory rail mounting system of claim 6, wherein the accessory rail at the installed position abuts the floor.

8. The accessory rail mounting system of claim 1, wherein the accessory rail defines a length, the length being adjustable.

9. The accessory rail mounting system of claim 8, wherein adjusting the length of the accessory rail adjusts a distance from the first notch to the second notch.

10. The accessory rail mounting system of claim 1, further comprising a first latch at the first notch and a second latch at the second notch.
